(19) United States
(12) Patent Application Publication
(10) Pub. No.: US 2008/0288184 A1
(43) Pub. Date: Nov. 20, 2008

(54) Automatic Signal Collection and Analysis for Piezoelectric Wafer Active Sensor

(75) Inventors: Victor Giurgiutiu, Columbia, SC (US); Buli Xu, West Columbia, SC (US); Weiping Liu, West Columbia, SC (US)

Correspondence Address: DORITY & MANNING, P.A., POST OFFICE BOX 1449, GREENVILLE, SC, 29602-1449, US

(73) Assignee: UNIVERSITY OF SOUTH CAROLINA, Columbia, SC (US)

(21) Appl. No.: 11/659,071

(22) PCT Filed: Aug. 5, 2005
(86) PCT No.: PCT/US05/28016

§ 371 Date: Apr. 7, 2008

Related U.S. Application Data
(60) Provisional application No. 60/599,155, filed on Aug. 5, 2004.
(60) Provisional application No. 60/599,153, filed on Aug. 5, 2004.

(51) Int. Cl. G01B 5/28

(52) U.S. Cl. 702/35; 702/39

(57) ABSTRACT

Disclosed is an apparatus and methodology for monitoring the health of a structure. Apparatus and methodologies are disclosed for applying a controlled signal sequence to an array of piezoelectric wafer active sensors and for analyzing echo returns from the applied signals to determine the health of the monitored structure. The applied signal may take on certain characteristics including being provided as a specially tailored chirp signal to compensate for non-linear characteristics of the monitored structure.

### PRIORITY CLAIM

This application claims priority to previously filed U.S. Provisional Application entitled “FEMIA—Fast Electromechanical Impedance Algorithm” assigned Ser. No. 60/599,155, and U.S. Provisional Application entitled “ASCU-PWAS —Automatic Signal Collection Unit for PWAS-based Structural Health Monitoring” assigned Ser. No. 60/599,153, both filed on Aug. 5, 2004 which are incorporated herein by reference for all purposes.

### FIELD OF THE INVENTION

The present subject matter relates to structural health monitoring (SHM). More specifically, the present subject matter relates to automatic signal collection units (ASCU) and analysis of data collected from such ASCUs generated from in-situ piezoelectric wafer active sensors (PWAS) to determine the health of a monitored structure.

### BACKGROUND OF THE INVENTION

Structural health monitoring (SHM) is a method of determining the health of a structure from the readings of an array of permanently attached sensors that are embedded into a structure and monitored over time. SHM can be performed as either passive or active monitoring. Passive SHM consists of monitoring a number of parameters including, but not limited to, loading stress, environment action, performance indicators, and acoustic emission

from cracks, and inferring the state of structural health from a structural model. In contrast, active SHM performs proactive interrogation of the structure, detects damage, and determines the state of structural health from the evaluation of damage extend and intensity. Both approaches aim at performing a diagnosis of the structural safety and health, to be followed by a prognosis of the remaining life.

Passive SHM uses passive sensors which only “listen” but do not interact with the structure. Therefore, they do not provide direct measurement of the damage presence and intensity. Active SHM uses active sensors that interact with the structure and thus determine the presence or absence of damage. Methods used for active SHM resemble those of nondestructive evaluation (NDE), e.g., ultrasonics, eddy currents, etc., except that they are used with embedded sensors. Hence, active SHM could be seen as a method of embedded NDE. One widely used active SHM method employs piezoelectric wafer active sensors (PWAS), which send and receive Lamb waves and determine the presence of cracks, delaminations, disbonds, and corrosion. Due to its similarities to NDE ultrasonics, this approach is also known as embedded ultrasonics.

With respect to SHM equipment per se, several investigators have explored means of reducing the size of the impedance analyzer, to make it more compact, and even field-portable. Alternative ways of measuring the electromechanical (E/M) impedance, which are different from those used by the impedance analyzer, have also been considered.

Known methods of measuring E/M impedance use sinusoidal excitation signals at predetermined frequency values in the frequency range of interest. For measuring impedance at a given frequency, an excitation at this certain frequency is needed. That is to say, to plot an impedance spectrum of a PWAS with 401 frequency points, 401 different frequencies excitations have to be generated, sampled and analyzed. Such method is not time efficient to address this issue, thus an improved methodology for impedance measurement is needed.

While various implementations of automatic signal switching units and signal analysis methodologies have been developed, no design has emerged that generally encompasses all of the desired characteristics as hereafter presented in accordance with the subject technology.

### SUMMARY OF THE INVENTION

In view of the recognized features encountered in the prior art and addressed by the present subject matter, an improved apparatus and methodology for monitoring the health of a structure has been provided.

In accordance with aspects of certain embodiments of the present subject matter, methodologies are provided to employ a piezoelectric wafer active sensor (PWAS) array to obtain images of structural anomalies in a structure under test.

In accordance with certain aspects of other embodiments of the present subject matter, methodologies have been developed to automatically collect data using the combined capabilities of specific hardware and related computerized control via customized software.

In accordance with other aspects of other embodiments of the present subject matter an automatic signal collection unit (ASCU) employing piezoelectric wafer active sensors for structural health monitoring (ASCU-PWAS) has been provided. By using Lamb waves on the surface of thin-wall structures, one can detect the existences and positions of cracks or corrosions in the structure.

In accordance with yet additional aspects of further embodiments of the present subject matter, apparatus and accompanying methodologies have been developed to sequentially energize each of the transceiver elements of the PWAS array such that, during the sequence, each transceiver element operates in turn as a transmitting element while the remaining transceiver elements operate as receiving elements.

According to yet still other aspects of additional embodiments of the present subject matter, methodologies have been developed to provide a fast electromechanical (E/M) impedance algorithm (FEMIA) as an effective technique to directly measure the high-frequency local impedance spectrum of a structure or device under test.

Additional objects and advantages of the present subject matter are set forth in, or will be apparent to, those of ordinary skill in the art from the detailed description herein. Also, it should be further appreciated that modifications and variations to the specifically illustrated, referred and discussed features and elements hereof may be practiced in various embodiments and uses of the invention without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the present subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic representation of an exemplary measurement array and associated measurement equipment for assessing the structural health of a sample specimen;

FIG. 2 is a partial schematic of an exemplary decoding circuit useful for coupling a sensor array to associated measurement equipment;

FIG. 3 illustrates an exemplary Graphical User Interface (GUI) associated with software as may be used in association with the measure equipment in accordance with the present subject matter;

FIG. 4 illustrates a configuration for impedance measurement using a transfer function of a device under test (DUT);

FIGS. 5(a) and 5(b) respectively illustrate a chirp signal and the amplitude spectrum of a chirp signal as employed in the present subject matter;

FIGS. 6(a) and 6(b) respectively illustrate a frequency-swept signal and the amplitude spectrum of the frequency-swept signal as employed in the present subject matter;

FIG. 7 is the schematic of the impedance measurement circuit in simulation;

FIGS. 8(a) and 8(b) respectively represent the simulated voltage amplitude spectrums and current amplitude spectrums of chirp signal source and frequency swept signal source for free PWAS impedance measurement;

FIGS. 9(a) and 9(b) respectively represent the voltage and current of PWAS using chirp signal source for impedance measurement;

FIGS. 10(a) and 10(b) respectively represent the voltage and current of PWAS using frequency-swept signal source for impedance measurement;

FIGS. 11(a) and 11(b) respectively represent amplitude spectrum of recorded voltage and current for PWAS impedance measurement using chip signal source. FIGS. 11(c) and 11(d) respectively represent comparisons of measurements of PWAS impedance real and imaginary part impedance measurements as obtained by a known impedance analyzer and by the methodologies of the present subject matter; and

FIGS. 12(a) and 12(b) respectively represent amplitude spectrum of recorded voltage and current for PWAS impedance measurement using frequency-swept source. FIGS. 12(c) and 12(d) respectively represent comparisons of measurements of PWAS impedance real and imaginary part impedance measurements as obtained by a known impedance analyzer and by the methodologies of the present subject matter.

Repeat use of reference characters throughout the present specification and appended drawings is intended to represent same or analogous features or elements of the invention.

### DETAILED DESCRIPTION OF THE PREFERRED EMBODIMENTS

As discussed in the Summary of the Invention section, the present subject matter is particularly concerned with structural health monitoring and the analysis of structural health related signals collected using piezoelectric wafer active sensor (PWAS) arrays to obtain images of structural anomalies in a structure under test.

Selected combinations of aspects of the disclosed technology correspond to a plurality of different embodiments of the present invention. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

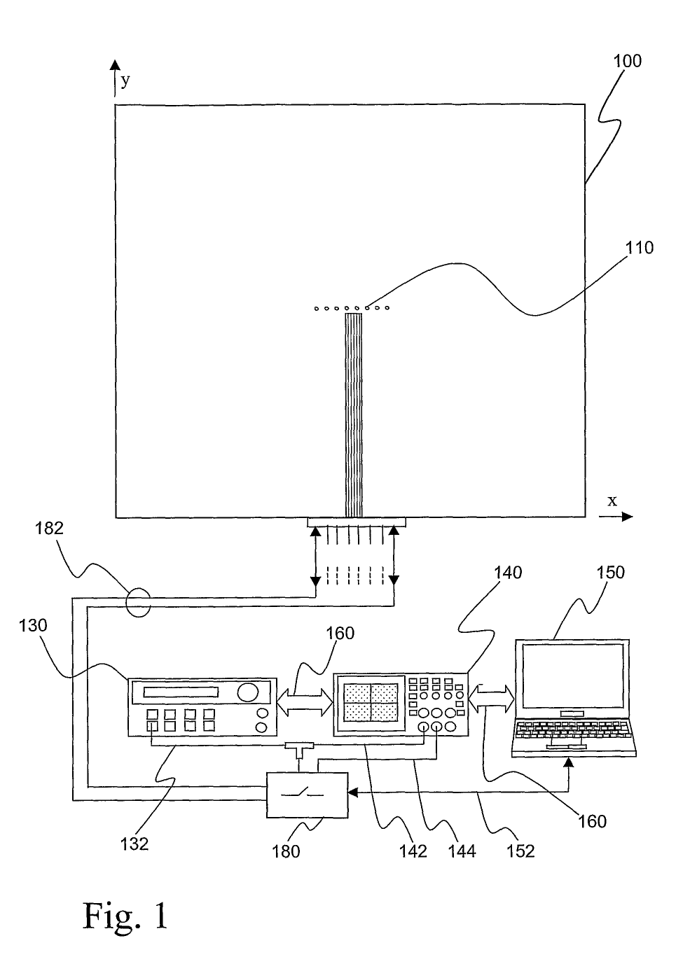

Reference will now be made in detail to the presently preferred embodiments of the subject structural health monitoring apparatus and methodologies. Referring now to the drawings, FIG. 1 illustrates a schematic representation of an exemplary measurement array and associated measurement equipment for assessing the structural health of a sample specimen 100. In the present example, sample specimen 100 may correspond to an aluminum plate, although such is not a limitation of the present subject matter.

A PWAS array 110 may be affixed to specimen 100 and may correspond to an arrangement of eight transceiver elements, although more or less elements may be provided depending of the specific nature of the structure under investigation. In addition, the individual elements of the PWAS array 120 may be positioned in a uniform geometric arrangement although such is not a limitation of the present technology.

In accordance with the present technology, a measurement procedure may be performed as follows. An excitation signal from a function generator 130 is sent to one element in the PWAS array 110 where the signal is transformed into Lamb waves. The Lamb waves travel in the structure 100 under investigation and are reflected/diffracted by any structural discontinuities, boundaries, damaged areas or other anomalies. The reflected/diffracted waves arrive back at the PWAS array 110 where they are transformed back into electric signals by operation of the individual PWAS array elements.

A data acquisition (DAQ) device, e.g., a digital oscilloscope 140, collects signals received at each PWAS element, including the transmitting PWAS element. Once the signal collection for one PWAS element acting as an exciter or transmitter has been finalized, the cycle is repeated for the other PWAS elements in a round-robin fashion.

In an exemplary configuration using eight transceiver elements in the PWAS array, there will be eight such measurement cycles to complete the data collection process. The function generator 130 and digital oscilloscope 140 may be connected to a personal computer (PC) 150 through a general-purpose interface bus (GPIB) 160, such that the desired waveform of the excitation signal can be generated. Collected waveforms are then transferred to the PC 150 for analysis as will be explained more fully later. A similar concept may be used in conjunction with an impedance analyzer for collection of electromechanical (E/M) impedance data.

The automation of data collection in accordance with the present technology consists of two parts. A first part, a hardware part, corresponds to an automatic signal switch box 180 and a second part, a software part, corresponding to a PC control program. In an exemplary method of operation, digital control signals are generated by the PC software and sent to the switch box 180 through a parallel port associated with PC 150 by way of a standard parallel cable 152. It should be appreciated, however, by those of ordinary skill in the art that other signal transfer methodologies and apparatus could be used, including, but not limited to, serial ports, infrared ports, USB ports, FireWire (IEEE 1394) ports, and wireless connections including WiFi and Bluetooth® technology. In addition, although reference is made herein to a personal computer (PC) and associated software, the use of such is not a specific requirement of the present subject matter as other devices including microprocessors, microcontrollers, application specific integrated circuits (ASIC) devices and other known devices may be employed to carry out the recited functions.

In the illustrated exemplary configuration, the PWAS array 110 may be connected to the switch box 180 with an 8-wire ribbon bus 182. The function generator 130 and digital oscilloscope 140 may be connected to the switch box with coaxial cables 132, 142, and 144. Switch box 180 is connected to the parallel port of the control PC 150 by way of standard parallel cable 152 to receive digit control signals from the PC 150 as made available by operation of the software part of the present technology as previously mentioned.

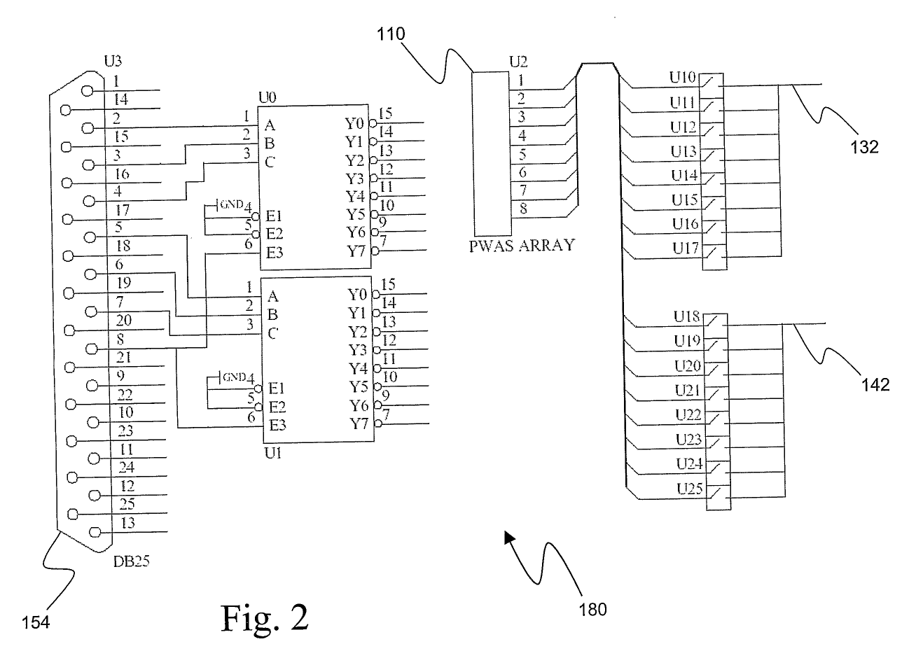

In the present exemplary configuration, in response to control signals from the parallel port of the PC 150 the switch box 180, as will be described more fully with respect to FIG. 2, will connect the function generator 130 and digital oscilloscope 140 each to one sensor (these two sensor can be the same sensor) of the PWAS array 110 respectively. Thus, one signal measurement route is constructed, an excitation signal is transmitted to the PWAS array 110 and echo signals are received by the digital oscilloscope 140 by way of selected individual elements of the PWAS array 110. Under this methodology, measurement loops are performed automatically under the control of the PC software.

With reference now to FIG. 2, there is illustrated a partial schematic of an exemplary decoding circuit useful for coupling PWAS array 110 to the associated measurement equipment. The hardware of the switch box consists of two main portions: a decoding portion corresponding to decoding components for the digit control signals from PC 150 and a switch portion corresponding to a reed-relay network.

The decoding portion converts digit control signals from the parallel cable 152 connected to the PC parallel port and give out control voltage to the reed-relays U10-U25. A standard PC parallel port has 8 output digital lines and a number of handshaking lines primarily suited for printers. In this design of auto switch, only digit signals need to be sent out and the handshaking signals may be ignored. If the printer handshake signals BUSY and PE are left unwired indicating that the printer is busy and is out of paper, some software products, for example LabVIEW as may be used with the present subject matter, may return an error signal. Grounding these two inputs will tell the parallel port that the device is ready to accept data and will solve this problem.

Digital signals generated by the LabVIEW software through the PC 150 parallel port are sent directly to the decoding components of the switch box 180 via a standard 25 pin, DB-25 connector 154 to a pair of 3 line input to 8 line output decoders U0, U1 to control the reed relays U10-U25. Reed-relays have been chosen in this exemplary configuration to provide a low-cost but reliable switch matrix, however it should be appreciated by those of ordinary skill in the art that other switching device, including, but not limited to, solid-state devices, might be used.

The reed-relays U10-U25 are divided into two groups, one group U10-U17, for signal transmission from the signal generator 130 via cable 132 to the PWAS array 110 and another group, U18-U25, for signal reception from the PWAS array 110 to the digital oscilloscope 140 via connecting cable 142. For each of the transmission relays U10-U17, one pin is connected to the signal generator 130 and the other pin is connected to one of the PWAS sensor elements. For each of the reception relays U18-U25, one pin is connected to digital oscilloscope 140 and the other pin is connected to one of the PWAS sensor elements. At one time the control voltage from the decoding devices U0, U1 will switch on one transmission relay and one reception relay, thus the measurement route is connected.

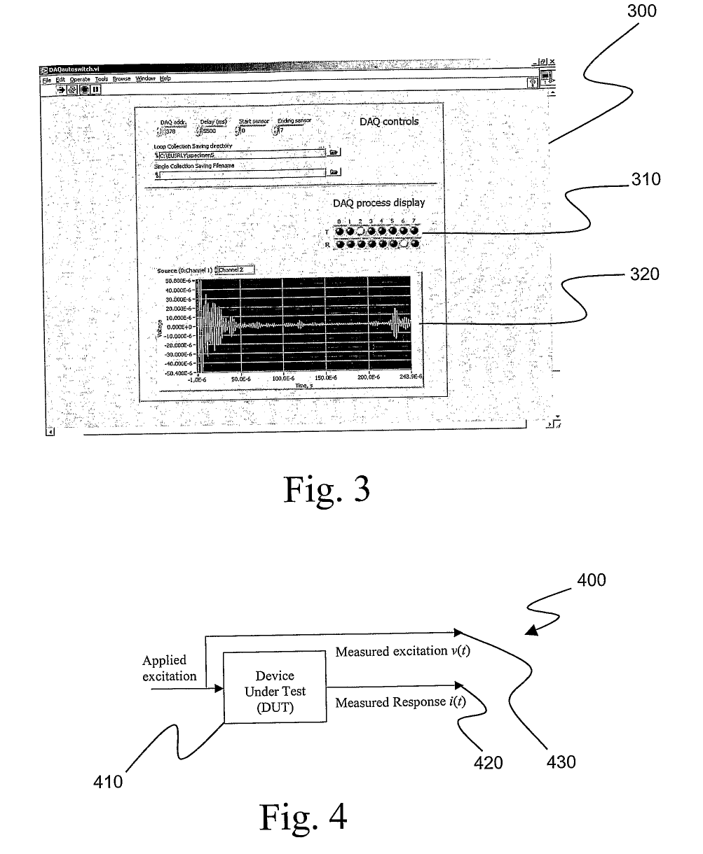

With reference to FIG. 3, there is illustrated an exemplary Graphical User Interface (GUI) as may be used in association with the software portion of the automatic data collection device of the present subject matter. In accordance with an exemplary configuration of the present subject matter, the software developed for the present subject matter has been created in LabVIEW to control the operation of the hardware portion of the automatic data collection device. It should be borne in mind that the use of LabVIEW software as described herein is not a limitation of the present subject matter but illustrative only of an exemplary configuration of the present subject matter.

In accordance with the illustrated exemplary configuration of the present subject matter, the “out port” function in LabVIEW is used to send digital signals through PC 150's parallel port. The LabVIEW software provides a graphic user interface (GUI) 300 to facilitate the data collection from the PWAS array 110. With the GUI 300, a user can configure the switch unit 180 to work in an auto signal-acquiring mode in which signals transmitted to and received from assigned sensors can be completed automatically without changing the hardware connection by hand.

When the auto switch 180 is in the automatic mode, a user may enter two numbers and a path name. The auto switch 180 will perform the measurement loops that start from the first number until the second number and the data from these measurement loops will be saved in that path. When in a manual mode, the auto switch 180 will allow a user to collect data with the transmitting and receiving sensors specified by the two number inputs. After these parameters are defined, the control software will send out 8-bit digit signals through PC 150's parallel port and these signals will then be decoded by decoders U0, U1 to control the reed-relays U10-U25 as previously described.

In an exemplary configuration of GUI 300, two rows of indicating LEDs 310 may be lit in green colors to show which sensor is transmitting excitation signals and which one is used to receive echo signals. During the data collection process, a representative waveform 320 will also be displayed on GUI 300.

The control program is easy to implement and can be integrated into an upper level program that executes the whole task of signal acquisition and analysis. Because of the concise design of the hardware, the concept of the auto signal switch can be extended to electromechanical (E/M) impedance measurement for SHM.

With reference to FIG. 4, there is illustrated a configuration for impedance measurement using a transfer function of a device under test (DUT) 410 in accordance with the present subject matter. The electromechanical (E/M) impedance method in accordance with the present subject matter is an embedded ultrasonics method that provides an effective and powerful technique for structural health monitoring (SHM). Through piezoelectric wafer active sensors (PWAS) permanently attached to a structure, the E/M impedance method is able to measure directly the high-frequency local impedance spectrum of the structure.

Because the high-frequency local impedance spectrum is much more sensitive to incipient damage than the low-frequency global impedance, the E/M impedance method is better suited for applications in structural health monitoring than other more conventional methods. The E/M impedance method in accordance with the present subject matter utilizes as its main apparatus an impedance analyzer that reads the in-situ E/M impedance as a measured response (on line 420) of the PWAS attached to the monitored structure in an arrangement substantially as illustrated in FIG. 1. The applied excitation signal from signal generator 130 (FIG. 1) may also be read as a measured excitation signal on line 430 (FIG. 4) for use in the impedance calculations.

For a linear system, by transforming the time domain excitation signal (voltage [v(t)]) and response signal (current [i(t)]) of the device under test (DUT) 410 to yield the frequency domain quantities [V(jω) and I(jω)], the admittance of DUT 410 may be calculated as the transfer function of the DUT 410.

$$Y ( jω ) = \frac{I ( jω )}{V ( jω )} \qquad ( 1 )$$

Hence, the impedance of DUT 410 is

$$Z ( jω ) = \frac{F F T \{ v ( t ) \}}{F F T \{ i ( t ) \}} \qquad ( 2 )$$

where, FFT { } designates fast Fourier transform. With this method, the impedance spectrum of DUT 410 can be acquired even within only one excitation signal sweeping. The efficiency of the impedance measurement can thus be dramatically improved.

From Equation (2), we can see that any arbitrary time domain excitation can be used to measure the system impedance provided that excitation is applied and the response signal is recorded over a sufficiently long time to complete the transforms over the desired frequency range. Two digitally synthesized signal sources (linear chirp signal and frequency swept signal) were explored for E/M impedance measurement:

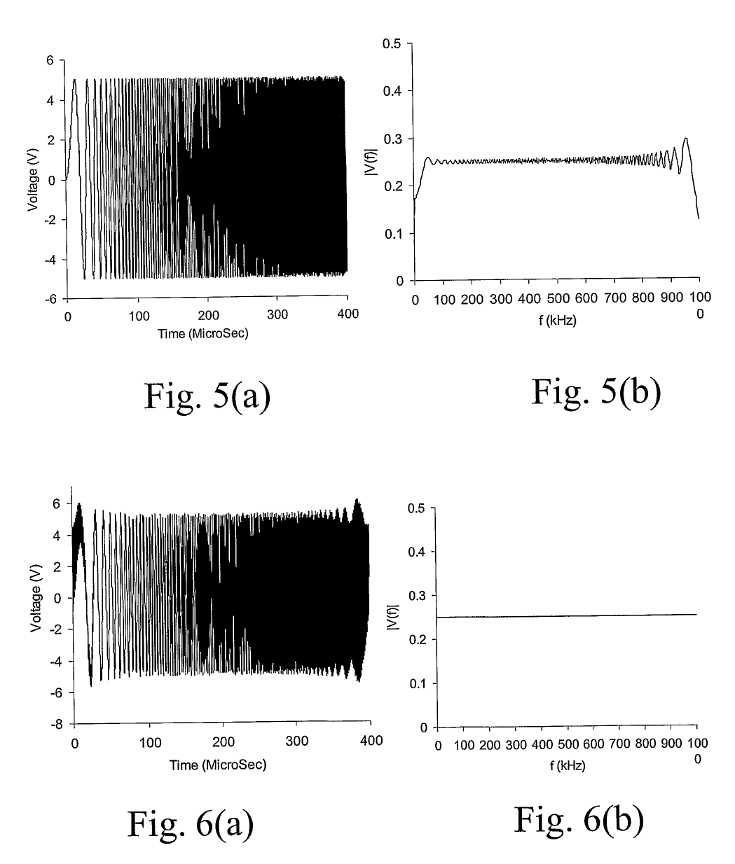

Linear chirp can be synthesized easily in time domain (FIG. 5a). Consider a general signal x(t)=Re{Ae^{jφ(t)}}, a linear chirp signal is produced when

φ(t)=λβt²+2πf₀t+φ₀ (3)

Computing the instantaneous frequency, fᵢ, of the chirp, we have fᵢ(t)=βt+f₀. The parameter β=(f₁−f₀)/t₁ is the rate of frequency change, which is used to ensure the desired frequency breakpoint fᵢ at time tᵢ is maintained. FIG. 5b shows the amplitude spectrum of a linear chirp signal that has a continuous flat frequency spectrum from DC to 1 MHz. However, there are some unwanted ripples in its spectrum. The energy of the sweep in a particular frequency region is not a constant.

Constructing the sweep in the frequency domain avoids this problem. The synthesis can be implemented by defining the magnitude and group delay:

$$v ( {t}_{i} ) = {\sum }_{k = {f}_{start}}^{{f}_{end}} cos ( 2 π {kt}_{i} + {θ}_{k} ) \qquad ( 4 )$$

where,

θₖ=θₖ₋₁+(k−fₛₜₐᵣₜ)Δθ (5)

Δθ=−2π/(f_{end}−fₛₜₐᵣₜ) (6)

θ_{fstart-1}=0 (7)

FIG. 6a shows a synthesized frequency swept signal defined by Equation (4)˜(7). The synthesized signal has a very flat amplitude spectrum from DC to 1 MHz (FIG. 6b)

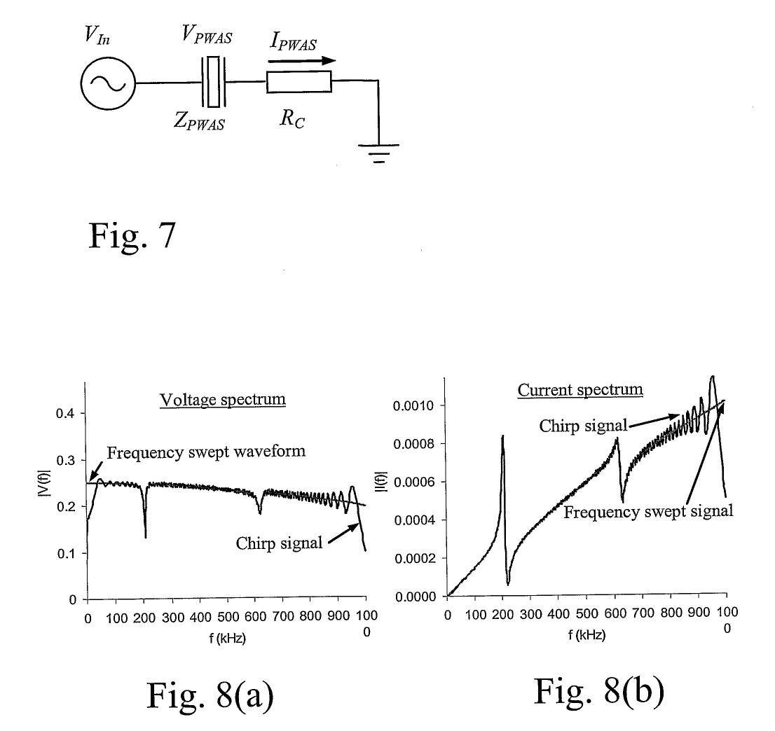

To compare these two signal sources for impedance measurement, a simulation for measuring the impedance spectrum of a free PWAS was conducted using the circuit in FIG. 7. A low value resistor Rc in series with the PWAS was employed for current measurement. Therefore, the voltage across the PWAS, VPWAS and the current flow through the PWAS, IPWAS in frequency domain are determined by Equation (8) and (9) respectively.

$$\begin{matrix}{V}_{P W A S} ( f ) = \frac{{Z}_{P W A S} ( f )}{{Z}_{P W A S} ( f ) + {R}_{c}} {V}_{In} ( f ) & ( 8 ) \\ {I}_{P W A S} ( f ) = \frac{{V}_{In} ( f )}{{Z}_{P W A S} ( f ) + {R}_{c}} & ( 9 )\end{matrix}$$

where, Z_{PWAS} designates PWAS impedance. For simplicity, 1-D PWAS model was selected in simulation:

$${Z}_{P W A S} ( ω ) = {\frac{1}{iω \cdot \overline{C}} [ 1 - {\overline{k}}_{31}^{2} ( 1 - \frac{1}{\overline{ϕ} cot \overline{ϕ}} ) ]}^{- 1} \qquad ( 10 )$$

where, ω is the angular frequency, k̅₁₃² is the complex coupling factor; C̅ is the capacitance of PWAS; φ̅ is a notation equal

$$\frac{1}{2} γ l ,$$

γis the wavenumber and l is the PWAS length.

Equation (8) and (9) permit the calculation of amplitude spectrums of voltage, V_{PWAS} and current, I_{PWAS} (FIG. 8). As we can see in FIG. 8, there are some ripples in the voltage and current spectrums for chirp signal source, while spectrums for frequency swept signal source are smoother. Due to the change of PWAS impedance at anti-resonance frequency points and also the change of PWAS admittance at resonance frequency points, the first valley in voltage spectrum was observed at the first resonance frequency point, while the first valley in current spectrum was observed at the first anti-resonance frequency point.

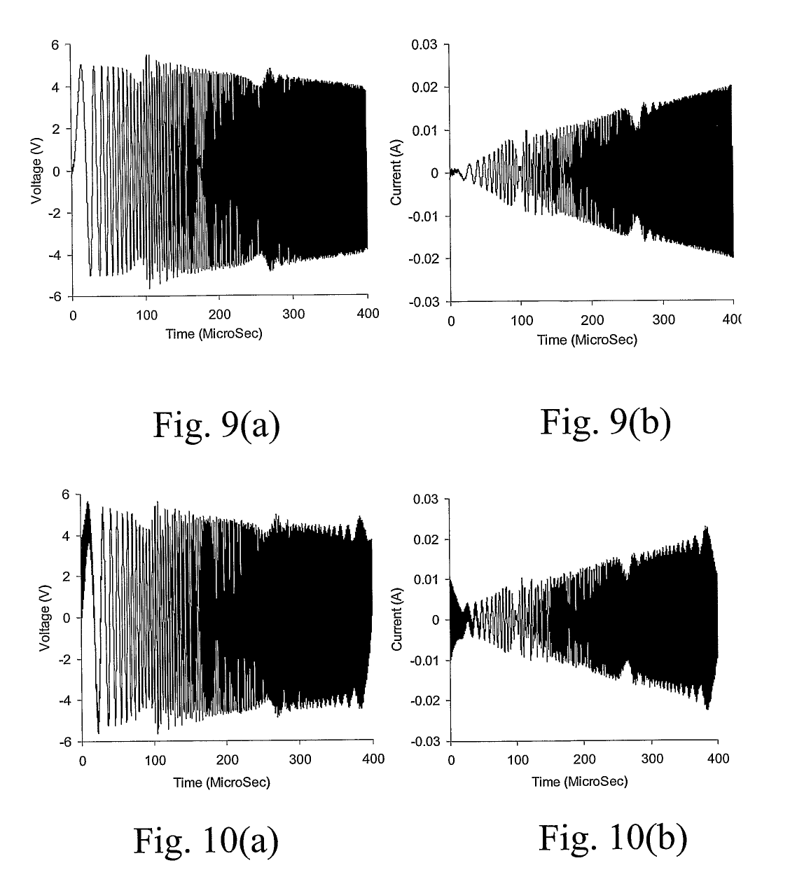

Inverse Fourier transforms of Equation (8) and (9) give the voltage V_{PWAS}(t) and current, I_{PWAS}(t) in time domain respectively. FIG. 9 and FIG. 10 show the waveforms of V_{PWAS}(t) and I_{PWAS}(t) when using chirp signal source and frequency swept signal source as excitations for free PWAS impedance measurement, respectively. A comparison of FIG. 9b and FIG. 10b indicates that frequency swept signal source possesses larger current response than chirp signal source in low frequency range for impedance measurement. Therefore, frequency swept signal source may have higher SNR in low frequency range for impedance measurement.

An experimental implementation of the fast electromechanical impedance algorithm (FEMIA) in accordance with the present subject matter was performed using standard multipurpose laboratory equipment including a function generator, a PCI DAQ card, a PCI GPIB card, a calibrated resistor (100 ohms) and a PC with a LabVIEW software package installed. Digitally synthesized signal sources were first uploaded to non-volatile memory slots of function generator (HP33120A, 12-bit 80 MHz internal D/A converter) by using LabVIEW program. The function generator, which was controlled by a PC LabVIEW program via GPIB card, outputs the uploaded excitation with its frequency equal to the frequency resolution (sample rate/buffer size) of the synthesized signal source and its amplitude at 10V peak to peak. The actual excitation and the response of the PWAS were recorded synchronously by a two-channel DAQ card (8-bit, 10 MHz sample rate, 4000 points of buffer size). The DAQ card was activated after running of the function generator with a certain amount of delay to ensure the response to stabilize. The impedance spectrum of the PWAS equals Fast Fourier Transform (FFT) of the excitation over the FFT of the response signal. To improve accuracy and repeatability of measurement, averaging was performed on measurement spectrums instead on time records.

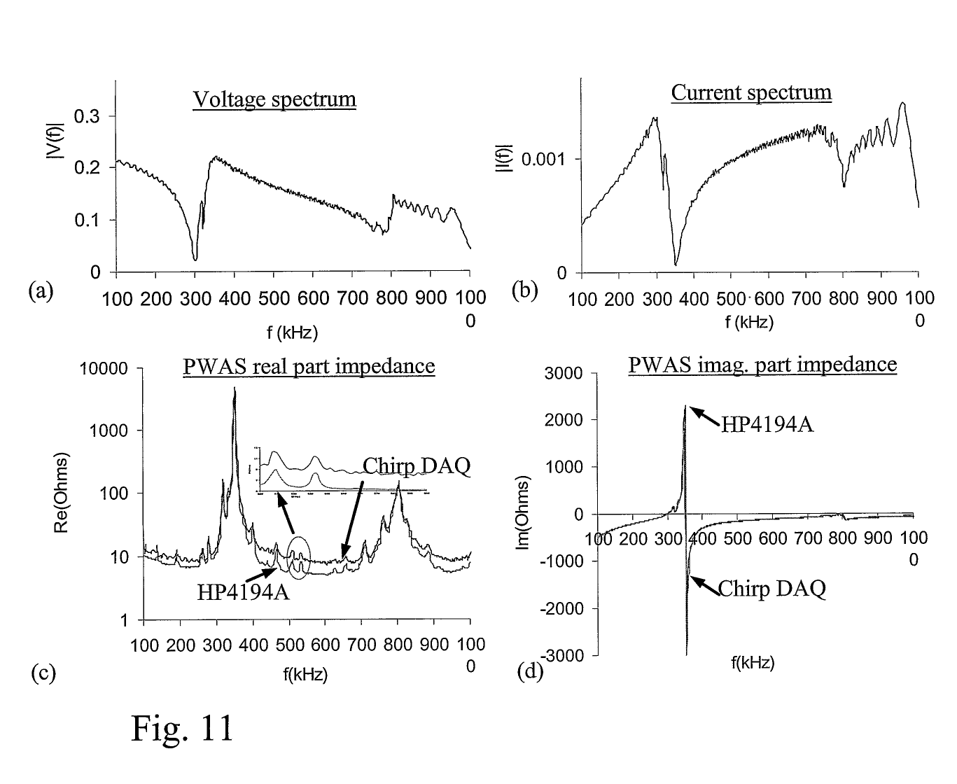

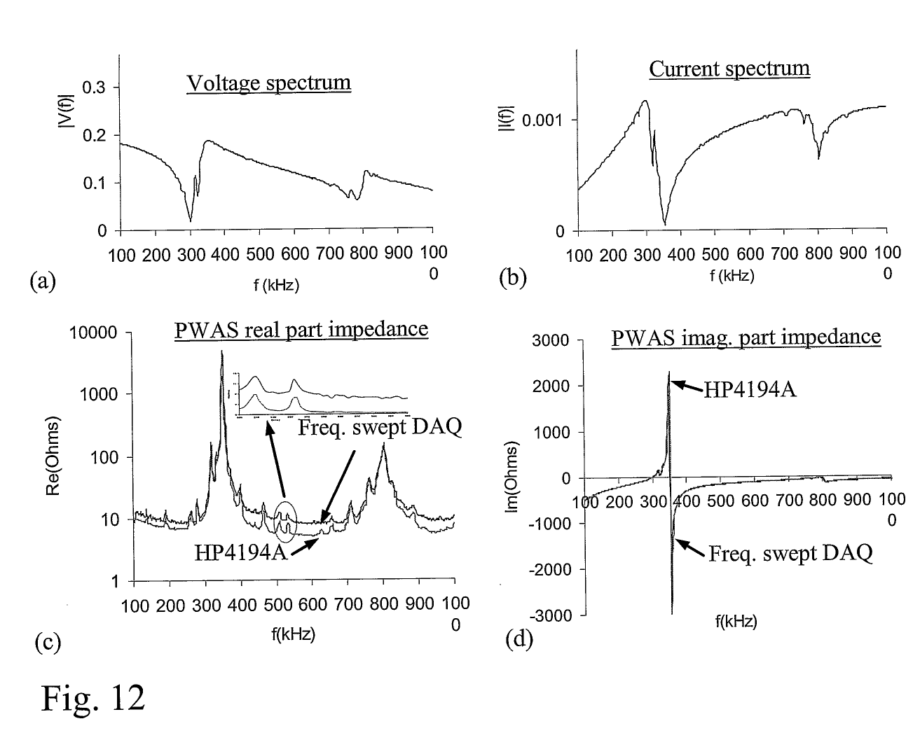

FIG. 11 and FIG. 12 show the superposed results obtained by the fast electromechanical impedance algorithm (FEMIA) in accordance with the present subject matter using synthesized sources (chirp signal source and frequency swept signal source) after 256 times of averaging and that obtained with a standard laboratory impedance analyzer (an HP4194A) when measuring a free piezoelectric wafer active sensor (PWAS).

Both of the synthesized signal sources can capture the free PWAS impedance spectrums precisely including the small peaks in the impedance spectrums (FIG. 11c &d and FIGS. 12c & d). For the chirp signal source, small ripples were observed in the voltage and current spectrums in high frequency range (FIG. 11a & b). Comparison of the circled parts of impedance spectrums in FIG. 11c and FIG. 12c showed that frequency swept signal source gave smoother impedance spectrum (FIG. 12c) than the one measured by chirp signal source (FIG. 11c). This indicates that the frequency swept signal may be the better signal source for impedance spectrum measurement than the chirp signal.

Even when all precautions have been taken to guarantee a high-precision measurement, it cannot be denied that, unexplainable small differences between the impedance spectrums measured by HP4194A impedance analyzer and the new impedance measurement method. The reasons for these differences are not obvious, although perhaps accuracy of calibrated resistor or terminal configuration may have some effects. For HP4194A impedance analyzer, it is generally equipped with four-terminal configuration (Hc, Hp, Lp and Lc) to interconnect with DUT. This reduces the effects of lead inductance, lead resistance, and stray capacitance between leads. While the novel impedance analyzer only employs the simple two-terminal configuration.

Also worth noting is that the precision of the new impedance measurement system can be further improved by increase the buffer size of the system (increasing spectral resolution) or by decreasing the frequency sweeping range in the synthesized signal source (span less while sweeping longer in certain frequency range).

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. An automatic signal collection apparatus, comprising:
a signal generator;
a signal receiver;
a plurality of transceiver elements;
a signal switch; and
a computer,
wherein the computer is programmed to perform a measurement sequence by causing the automatic signal switch to successively couple individual ones of the plurality of transceivers to said signal generator while coupling the remainder of the plurality of transceivers to said signal receiver until all individual ones of the plurality of transceivers have been coupled to said signal generator at least once during the measurement sequence.

2. The automatic signal collection apparatus of claim 1, further comprising
a structure,
wherein the plurality of transceiver elements are physically attached to said structure.

3. The automatic signal collection apparatus of claim 2, wherein the plurality of transceiver elements are arranged in an array.

4. The automatic signal collection apparatus of claim 1, wherein the plurality of transceiver elements are piezoelectric wafer active sensors.

5. The automatic signal collection apparatus of claim 1, wherein the signal generator is configured to apply a chirp signal to the individual ones of the plurality of transceivers.

6. The automatic signal collection apparatus of claim 5, wherein the chirp signal has a frequency that is a linear function of time.

7. The automatic signal collection apparatus of claim 5, wherein the chirp signal has a frequency that is a quadratic function of time.

8. A structural health monitoring apparatus, comprising:
a structure to be monitored;
an array of transceiver elements secured to said structure;
a signal generator;
a signal receiver;
a signal switch; and
a computer;
wherein the computer is programmed to perform a measurement sequence by causing the automatic signal switch to successively couple individual ones of the plurality of transceivers to said signal generator while coupling the remainder of the plurality of transceivers to said signal receiver until all individual ones of the plurality of transceivers have been coupled to said signal generator at least once during the measurement sequence and to perform an analysis sequence by evaluating signals received by said signal receiver to determine whether anomalies are present in said structure.

9. The structural health monitoring apparatus of claim 8, wherein the plurality of transceiver elements are piezoelectric wafer active sensors.

10. The automatic signal collection apparatus of claim 8, wherein the signal generator is configured to apply a chirp signal to the individual ones of the plurality of transceivers.

11. The automatic signal collection apparatus of claim 10, wherein the chirp signal has a frequency that is a linear function of time.

12. The automatic signal collection apparatus of claim 10, wherein the chirp signal has a frequency that is a quadratic function of time.

13. The automatic signal collection apparatus of claim 8, wherein the analysis sequence includes determining the electromechanical impedance of at least a portion of said structure.

14. A method for evaluating the health of a structure, comprising the steps of:
transmitting a signal into the structure from a plurality of points seriatim;
listening for a return signal from a portion of the plurality of points; and
determining the electromechanical impedance of at least a portion of the structure based on the steps of transmitting and listening.

15. The method of claim 14, wherein the step of transmitting a signal comprises applying a signal to a transceiver element from a signal generator.

16. The method of claim 14, wherein the step of listening for a return signal comprises monitoring output signals from a plurality of transceiver elements.

17. The method of claim 15, wherein the step of applying a signal comprises applying a chirp signal from the signal generator to a transceiver element.

18. The method of claim 17, wherein the step of applying a chirp signal comprises applying a signal with a frequency that is a linear function of time.

19. The method of claim 17, wherein the step of applying a chirp signal comprises applying a signal with a frequency that is a quadratic function of time.
